(19) United States
(12) Patent Application Publication
(10) Pub. No.: US 2021/0125348 A1
(43) Pub. Date: Apr. 29, 2021

(54) Estimation of Atmospheric Turbulence Parameters using Differential Motion of Extended Features in Time-lapse Imagery

(71) Applicant: US Gov't as represented by Secretary of Air Force, Wright-Patterson AFB, OH (US)

(72) Inventors: Santasri Bose-Pillai, Beavercreek, OH (US); Jack McRae, Bellbrook, OH (US); Christopher Rice, Cedarville, OH (US); Steven Fiorino, Beavercreek, OH (US)

(21) Appl. No.: 17/077,323

(22) Filed: Oct. 22, 2020

Related U.S. Application Data
(60) Provisional application No. 62/924,745, filed on Oct. 23, 2019.

(51) Int. Cl. G06T 7/246; H04N 7/18; G01W 1/00

(52) U.S. Cl. CPC G06T 7/248; H04N 7/183; G01W 2001/003; G06T 2207/10048; G06T 2207/30232; G01W 1/00

(57) ABSTRACT

A system and method provide improved remote turbulence measurement. The system includes an image capturing device that captures frames of images of a target. A controller of the system tracks motion of one or more features of the images between frames using a pattern recognition algorithm. The controller computes subpixel motion based on results of the pattern recognition algorithm and computes differential motion or tilts between pairs of features. The controller computes differential tilt variances from every set of frames. The controller computes theoretical weighting functions for differential tilt variances. The controller determines weights to linearly combine weighting functions such that the combined weighting function closely resembles a desired weighting function that corresponds to the turbulence parameter of interest. The controller linearly combines the differential tilt variances using the determined weights to obtain the turbulence parameter of interest.

### CROSS-REFERENCE TO RELATED APPLICATIONS

This application claims the benefit of priority under 35 U.S.C. § 119(e) to U.S. Provisional Application Ser. No. 62/924,745 entitled “Estimation of Atmospheric Turbulence Parameters using Differential Motion of Extended Features in Time-lapse Imagery”, filed 23 Oct. 2019, the contents of which are incorporated herein by reference in their entirety.

### ORIGIN OF THE INVENTION

The invention described herein was made by employees of the United States Government and may be manufactured and used by or for the Government of the United States of America for governmental purposes without the payment of any royalties thereon or therefore.

### BACKGROUND

### 1. Technical Field

The present disclosure generally relates to optical or near infra-red air turbulence measurements system.

### 2. Description of the Related Art

Accurate characterization of atmospheric turbulence and its effects is extremely important for performance evaluation of optical systems operating in real environment and for designing of systems to mitigate turbulence effects. This analysis is relevant to laser communications, surveillance or tactical applications. Irradiance based methods such as the Scintillation, Detection and Ranging (SCIDAR) technique have been used in the past by astronomers to obtain a low resolution vertical profile of turbulence. [1, 2] The path-weighted refractive index structure constant, Cₙ² is traditionally measured using scintillometers. [3] However, irradiance based techniques are of limited use in the saturation regime and hence are not suitable for measurements over long paths through turbulence. Also, direct point estimates of Cₙ² that are derived from such intermediate quantities as the velocity structure constant, Cᵥ² and the temperature structure constant, C_{T}² require measurements of wind speed and temperature at high temporal resolution. [4] Use of these methods requires physical sensors to be deployed in and around the region of interest.

### SUMMARY

The present innovation overcomes the foregoing problems and other shortcomings, drawbacks, and challenges of measuring turbulence for surveillance systems, high energy laser testing that is affected by turbulence, a tactical weapon engagements scenario where accuracy is dependent on turbulence monitoring. While the present innovation will be described in connection with certain embodiments, it will be understood that the invention is not limited to these embodiments. To the contrary, this invention includes all alternatives, modifications, and equivalents as may be included within the spirit and scope of the present invention.

Scintillometers are gold standards for measuring turbulence. However, they have limited operational ranges since they suffer from saturation issues. They also require access to both ends of the path. Other turbulence measurement techniques such as the Differential Image Motion Monitor (DIMM), Scintillation, Detection and Ranging (SCIDAR), Slope, Detection and Ranging (SLODAR) and MZA Associates' Path Resolved Optical Profiler System (PROPS) require active sources at the target location. Some of these instruments require sophisticated instrumentation as well. The proposed technique is a low cost approach to remotely characterize turbulence from a single site without deployment of sensors or sources at the target location. MZA's Delayed Tilt Anisoplanatism (DELTA) is an imaging based technique that uses the turbulence induced motion of point features on a distant target to remotely profile turbulence. However, since point features are tracked, the operational range is limited. Our imaging technique is phase-based (hence no saturation) and it tracks motion of extended features rather than point features which allow the technique to be applied over longer ranges. The measured tilt variances can be linearly combined in such a way that the output can be made to mimic the output of any traditional turbulence measuring system as well. [5-8]

According to one aspect of the present innovation, a turbulence-compensating system includes: (i) an image capturing device that captures frames of images of a target; and (ii) a turbulence measurement system comprising a controller that is communicatively coupled to the image capturing device to receive the images. The controller tracks motion of one or more features of the images between frames using a pattern recognition algorithm. The controller computes subpixel motion based on results of the pattern recognition algorithm. The controller computes differential motion or tilts between pairs of features. The controller computes differential tilt variances from every set of frames. The controller computes theoretical weighting functions for differential tilt variances. The controller determines weights to linearly combine weighting functions such that the combined weighting function closely resembles a desired weighting function that corresponds to the turbulence parameter of interest. The controller linearly combines the differential tilt variances using the determined weights to obtain the turbulence parameter of interest.

According to one aspect of the present innovation, a method includes capturing frames of images a target using an image capturing device. The method includes tracking motion of one or more features of the images between frames using a pattern recognition algorithm. The method includes computing subpixel motion based on results of the pattern recognition algorithm. The method includes computing differential motion or tilts between pairs of features. The method includes computing differential tilt variances from every set of frames. The method includes computing theoretical weighting functions for differential tilt variances. The method includes determining weights to linearly combine weighting functions such that the combined weighting function closely resembles a desired weighting function that corresponds to the turbulence parameter of interest. The method includes linearly combining the differential tilt variances using the determined weights to obtain the turbulence parameter of interest.

Additional objects, advantages, and novel features of the invention will be set forth in part in the description which follows, and in part will become apparent to those skilled in the art upon examination of the following or may be learned by practice of the invention. The objects and advantages of the invention may be realized and attained by means of the instrumentalities and combinations particularly pointed out in the appended claims.

### BRIEF DESCRIPTION OF THE DRAWINGS

The description of the illustrative embodiments can be read in conjunction with the accompanying figures. It will be appreciated that for simplicity and clarity of illustration, elements illustrated in the figures have not necessarily been drawn to scale. For example, the dimensions of some of the elements are exaggerated relative to other elements. Embodiments incorporating teachings of the present disclosure are shown and described with respect to the figures presented herein, in which:

FIG. 1A depicts a diagram of an example ground-based experimental imaging setup showing the imaging system and the target, according to one or more embodiments;

FIG. 1B is a diagram of an example airborne imaging setup including an airborne imaging system and a ground target, according to one or more embodiments;

FIG. 2 is a graphical plot of path weighting functions of differential patch-averaged tilt variances for different patch sizes and separations, according to one or more embodiments;

FIG. 3A is a graphical plot of three path weighting functions, according to one or more embodiments;

FIG. 3B is a graphical plot of the linear combination of the three path weighting functions of FIG. 3A, according to one or more embodiments;

FIG. 4A is a graphical plot of two path weighting functions, according to one or more embodiments;

FIG. 4B is a graphical plot of linear combination of the two path weighting functions of FIG. 4A, according to one or more embodiments;

FIG. 5A is a map of an example imaging path;

FIG. 5B is an elevation profile of the imaging path;

FIG. 6A is an example image of the Dayton VA Medical Center captured early morning;

FIG. 6B is an example image of the Dayton VA Medical Center captured during the afternoon with patches tracked are marked as white circles in the lower right of FIG. 6A;

FIG. 7 is a graphical plot of a comparison of Cₙ² estimates from time-lapse imagery with Cₙ² from scintillometer, according to one or more embodiments;

FIG. 8 is a graphical plot of a comparison of Cₙ² estimates from time-lapse imagery with Cₙ² from scintillometer, according to one or more embodiments;

FIG. 9 is a graphical plot of a comparison of Cₙ² estimates from time-lapse imagery with Cₙ² from scintillometer, according to one or more embodiments;

FIG. 10 is a graphical plot of a comparison of Cₙ² estimates from time-lapse imagery with Cₙ² from scintillometer, according to one or more embodiments;

FIG. 11 is a diagrammatic illustration of an exemplary hardware and software environment of a turbulence measurement system managed by a controller, according to one or more embodiments;

FIG. 12A is a functional block diagram of an example system that uses a turbulence measurement system that enables improved performance by a turbulence-compensated surveillance system, according to one or more embodiments;

FIG. 12B is a functional block diagram of an example system that uses a turbulence measurement system to enable a nonlinear optimizer to provide turbulence profiles, according to one or more embodiments;

FIG. 12C is a functional block diagram of an example system that produces refractivity/refractive index gradient information, according to one or more embodiments; and

FIG. 13 presents a flow diagram of a method for time lapse remote measuring of air turbulence, according to one or more embodiments.

### DETAILED DESCRIPTION

According to aspects of the present disclosure, a system and method provide improved remote turbulence measurement. The system includes an image capturing device that captures frames of images of a target. A controller of the system tracks motion of one or more features of the images between frames using a pattern recognition algorithm. The controller computes subpixel motion based on results of the pattern recognition algorithm and computes differential motion or tilts between pairs of features. The controller computes differential tilt variances from every set of frames. The controller computes theoretical weighting functions for differential tilt variances. The controller determines weights to linearly combine weighting functions such that the combined weighting function closely resembles a desired weighting function that corresponds to the turbulence parameter of interest. The controller linearly combines the differential tilt variances using the determined weights to obtain the turbulence parameter of interest.

The present method relies on differential tilt measurements and hence is phase-based. As a result, conventional propagation theory can be used even for strong turbulence paths where the variance of irradiance saturates. Additionally, estimation can be done remotely from a single site using targets of opportunity. Some commercially available systems, such as the DELTA system developed by MZA estimate turbulence by tracking differential motion of feature points on the target. [9] In the present work, we track motion of extended features on the target rather than point features, which allows characterization over a longer range. A technique to linearly combine the differential tilt variances from pairs of features of different sizes and separations has been developed as well, that allows estimation of different turbulence parameters. Thus the time-lapse measurements can mimic the measurements coming from a scintillometer or any other instrument.

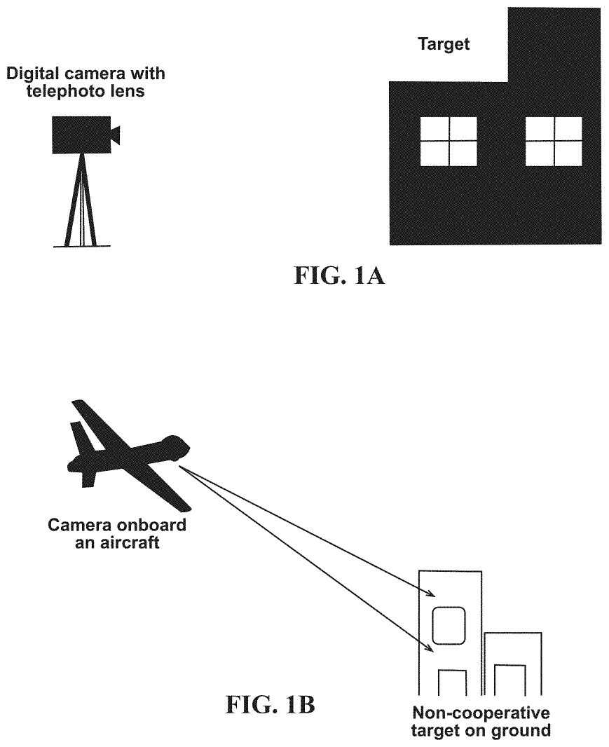

FIG. 1A depicts a diagram of an example ground-based experimental imaging setup 100a showing an imaging system 102a and a target 104a. FIG. 1B is a diagram of an example airborne imaging setup 100b including an airborne imaging system 102b and a ground target 104b. In one or more embodiments, an imaging system, comprising of an electronic camera, fitted with an imaging lens is used to capture several short exposure images of a distant target. The target should have sufficient trackable features on it. The imaging system is mounted on a tripod. The exposure time is selected such that the atmosphere is frozen during a single capture, yet sufficient signal is present in the images. The time interval between frames is selected such that the turbulence has changed between frames, and the tilts in adjacent frames are statistically independent. The imaging aperture should be such that some features and inter-feature separations are smaller than the aperture diameter and some features and separations are larger than the aperture diameter. This type of selection allows a rich set of measurements, which is useful in estimating turbulence parameters with different path-weighting functions.

The images are first cropped to isolate the region of interest. A reference image is chosen from the images collected and a cross-correlation algorithm is used to estimate the image shift between each image and the reference image. A Gaussian window is applied to the images before the cross-correlation algorithm is run. This reduces the effects of the frame edges on the correlation result. A parabolic fit is applied to the correlation peak to provide a sub-pixel estimate of the shift between the images. The correlation with a reference image provides information about the slow motion during the course of the day due to refractive bending. This long-term drift information is used to adjust the tracking window keeping it locked on to a feature through the collection. The cross-correlation algorithm is now applied to each image and its neighboring image to estimate the random motion of the feature due to turbulence. The shifts of two features are subtracted to get the differential signal. The differential mode of measurement eliminates the effects of common mode disturbances, such as platform vibrations.

B.1 Path Weighting Functions for Differential Patch-averaged Tilt Variance: The z-tilt over an aperture of diameter D, when viewing a source in the direction θ can be expressed as [9]:

$$α ( θ ) = \frac{32 λ}{{π}^{2} {D}^{4}} \int d r W ( r ) r ϕ ( r , θ ) , \qquad ( 1 )$$

where λ is the wavelength, ϕ(r, θ) is the turbulence induced wavefront distortion at aperture coordinate r and

$$W ( r ) = \{ \begin{matrix}1 & \vert r \vert \leq 0.5 D \\ 0 & \vert r \vert > 0.5 D\end{matrix} . \qquad ( 2 )$$

The mean correlation between tilts observed at the aperture due to two sources at viewing directions θ₁ and θ₂ can be written as,

$$〈 α ( {θ}_{1} ) \cdot α ( {θ}_{2} ) 〉 = {( \frac{32 λ}{{π}^{2} {D}^{4}} )}^{2} 〈 \int \int d r d {r}^{′} W ( r ) W ( {r}^{′} ) r \cdot {r}^{′} ϕ ( r , {θ}_{1} ) ϕ ( {r}^{′} , {θ}_{2} ) 〉 , \qquad ( 3 )$$

where the angled brackets indicate ensemble averaging. Interchanging the order of integration and ensemble averaging results in,

$$〈 α ( {θ}_{1} ) \cdot α ( {θ}_{2} ) 〉 = {( \frac{32 λ}{{π}^{2} {D}^{4}} )}^{2} \int \int d r d {r}^{′} W ( r ) W ( {r}^{′} ) r \cdot {r}^{′} 〈 ϕ ( r , {θ}_{1} ) ϕ ( {r}^{′} , {θ}_{2} ) 〉 . \qquad ( 4 )$$

Since ∫∫dx dr′W(r)W(r′)r·r′=0 terms which are functions of either r or r′, and not both, can be added without changing the result of the integration.

Hence, Eq. (4) becomes,

$$〈 α ( {θ}_{1} ) \cdot α ( {θ}_{2} ) 〉 = ( - \frac{1}{2} ) {( \frac{32 λ}{{π}^{2} {D}^{4}} )}^{2} \int \int d r d {r}^{′} W ( r ) W ( {r}^{′} ) r \cdot {r}^{′} {D}_{ϕ} ( r - {r}^{′} , {θ}_{1} - {θ}_{2} ) , \qquad ( 5 )$$

where D_{ϕ}(r−r′, θ₁−θ₂)= [symbol] [ϕ(r, θ₁)−ϕ(r′, θ₂)]² [symbol] is the phase structure function.

For a spherical wave propagating through turbulence characterized by the Kolmogorov power spectrum, the wave structure function can be written as, [11]

$$D ( r - {r}^{′} , {θ}_{1} - {θ}_{2} ) = 2. 91 {k}^{2} {\int }_{0}^{L} d z {C}_{n}^{2} ( z ) {\vert ( r - {r}^{′} ) ( 1 - \frac{z}{L} ) + z ( {θ}_{1} - {θ}_{2} ) \vert}^{5 / 3} , \qquad ( 6 )$$

where k=2π/λ is the wave number and L is the path length. The receiver is located at z=0 and the source is located at z=L. Assuming that the phase structure function is approximately equal to the wave structure function and substituting Eq. (6) in Eq. (5),

$$〈 α ( {θ}_{1} ) \cdot α ( {θ}_{2} ) 〉 = ( - \frac{2.91}{2} ) {( \frac{64}{π {D}^{4}} )}^{2} {\int }_{0}^{L} d z {C}_{n}^{2} ( z ) \int \int {drdr}^{′} W ( r ) W ( {r}^{′} ) r \cdot {r}^{′} \times {\vert ( r - {r}^{′} ) ( 1 - \frac{z}{L} ) + z ( {θ}_{1} - {θ}_{2} ) \vert}^{5 / 3} . \qquad ( 7 )$$

The integrations over r or r′ can be done using techniques outlined by Fried [12] and Winick et. al [13]. Applying those techniques, Eq. (7) reduces to

$$〈 α ( {θ}_{1} ) \cdot α ( {θ}_{2} ) 〉 = ( - \frac{2.91}{2} ) {( \frac{16}{π} )}^{2} {D}^{- 1 / 3} {\int }_{0}^{L} d z {C}_{n}^{2} ( z ) \times {\int }_{0}^{2 π} d ϑ {\int }_{0}^{1} d u [ ( u {cos}^{- 1} u ) - {u}^{2} ( 3 - 2 {u}^{2} ) \sqrt{1 - {u}^{2}} ] \times {[ {{u}^{2} ( 1 - \frac{z}{L} )}^{2} + {( \frac{z}{D} \vert {θ}_{1} - {θ}_{2} \vert )}^{2} + 2 u ( 1 - \frac{z}{L} ) ( \frac{z}{D} \vert {θ}_{1} - {θ}_{2} \vert ) cos ϑ ]}^{5 / 6 .} \qquad ( 8 )$$

Each pixel in the time-lapse imagery corresponds to a patch of finite size, not just a point on the target. Hence the shift (or the tilt) measured from the whole image, or even a pixel on the image is not tilt due to a single point source, but rather an average tilt due to several incoherent point sources over a patch. Since a Gaussian window is applied to the images before the cross-correlation is computed, to make the analysis consistent, the source patch is modeled as the same Gaussian. The patch-averaged tilt αₚ is defined as,

$${α}_{p} = \frac{\int d θ α ( θ ) {P}_{G} ( θ )}{\int d θ {P}_{G} ( θ )} , \qquad ( 9 )$$

where

$${P}_{G} ( θ ) = {e}^{- \frac{4 {θ}^{2} {L}^{2}}{{d}^{2}}} ,$$

d being the 1/e patch diameter and θ=|θ|.
The correlation between two patch-averaged tilts αₚ₁ and αₚ₂ is

$$〈 {α}_{p 1} \cdot {α}_{p 2} 〉 = \frac{\int \int d {θ}_{1} d {θ}_{2} 〈 α ( {θ}_{1} ) \cdot α ( {θ}_{2} ) 〉 {P}_{G} ( {θ}_{1} ) {P}_{G} ( {θ}_{2} - Δ θ )}{\int \int d {θ}_{1} d {θ}_{2} {P}_{G} ( {θ}_{1} ) {P}_{G} ( {θ}_{2} - Δ θ )} , \qquad ( 10 )$$

where Δθ is the angular separation between the two patches. The order of integration and ensemble averaging is interchanged to obtain the above expression. In the following analysis, the patches are assumed to be equal in size. The term with the angle brackets in Eq. (10) is nothing but the correlation of tilts due to two point sources. Substituting Eq. (8) in Eq. (10),

$$〈 {α}_{p 1} \cdot {α}_{p 2} 〉 = ( - \frac{2.91}{2} ) {( \frac{16}{π {A}_{p}} )}^{2} {D}^{- 1 / 3} {\int }_{0}^{L} d z {C}_{n}^{2} ( z ) \int \int d {θ}_{1} d {θ}_{2} {P}_{G} ( {θ}_{1} ) {P}_{G} ( {θ}_{2} - Δθ ) \times {\int }_{0}^{2 π} d ϑ {\int }_{0}^{1} d u [ ( u {cos}^{- 1} u ) - {u}^{2} ( 3 - 2 {u}^{2} ) \sqrt{1 - {u}^{2}} ] \times {[ {{u}^{2} ( 1 - \frac{z}{L} )}^{2} + {( \frac{z}{D} \vert {θ}_{1} - {θ}_{2} \vert )}^{2} + 2 u ( 1 - \frac{z}{L} ) ( \frac{z}{D} \vert {θ}_{1} - {θ}_{2} \vert ) cos ϑ ]}^{5 / 6} , \\ where {A}_{p} = \int d θ {P}_{G} ( θ ) = \frac{π {d}^{2}}{4 {L}^{2}} . \qquad ( 11 )$$

Eq. (11) can be equivalently expressed as,

$$\begin{matrix}〈 {α}_{p 1} \cdot {α}_{p 2} 〉 = ( - \frac{2.91}{2} ) {( \frac{16}{π {A}_{p}} )}^{2} {D}^{- 1 / 3} {\int }_{0}^{L} d z {C}_{n}^{2} ( z ) \int \int d {θ}_{1} d {θ}_{2}^{′} {P}_{G} ( {θ}_{1} ) {P}_{G} ( {θ}_{2}^{′} ) \times {\int }_{0}^{2 π} d ϑ {\int }_{0}^{1} d u [ ( u {cos}^{- 1} u ) - {u}^{2} ( 3 - 2 {u}^{2} ) \sqrt{1 - {u}^{2}} ] \times [ {{u}^{2} ( 1 - \frac{z}{L} )}^{2} + {( \frac{z}{D} \vert {θ}_{1} - {θ}_{2}^{′} - Δ θ \vert )}^{2} + 2 u ( 1 - \frac{z}{L} ) ( \frac{z}{D} \vert {θ}_{1} - {θ}_{2}^{′} - Δθ \vert ) cos ϑ ] 5 \text{/} 6 . \\ Let & ( 12 ) \\ {θ}_{1} - {θ}_{2}^{′} = \frac{d}{L} x , \\ {θ}_{1} + {θ}_{2}^{′} = \frac{2 d}{L} y . & ( 13 )\end{matrix}$$

Changing the variables of integration, Eq. (12) reduces to,

$$〈 {α}_{p 1} \cdot {α}_{p 2} 〉 = ( - \frac{2.91}{2 π} ) {( \frac{16}{π} )}^{3} {D}^{- 1 / 3} {\int }_{0}^{L} d z {C}_{n}^{2} ( z ) \int \int dxdy [ {e}^{- {( x + 2 y )}^{2}} {e}^{- {( 2 y - x )}^{2}} ] \times {\int }_{0}^{2 π} d ϑ {\int }_{0}^{1} d u [ ( u {cos}^{- 1} u ) - {u}^{2} ( 3 - 2 {u}^{2} ) \sqrt{1 - {u}^{2}} ] \times [ {{u}^{2} ( 1 - \frac{z}{L} )}^{2} + {( \frac{z d}{D L} \vert x - \frac{L}{d} Δ θ \vert )}^{2} + 2 u ( 1 - \frac{z}{L} ) ( \frac{z d}{D L} \vert x - \frac{L}{d} Δ θ \vert ) cos ϑ ] 5 \text{/} 6 . \\ Now , \int dy {e}^{- {( x + 2 y )}^{2}} {e}^{- {( 2 y - x )}^{2}} = \int dy {e}^{- 8 ( {y}^{2} + \frac{{x}^{2}}{4} )} = {\int }_{0}^{∞} d y {\int }_{0}^{2 π} d β [ y {e}^{- 8 ( {y}^{2} + \frac{{x}^{2}}{4} )} ] = \frac{π}{8} {e}^{- 2 {x}^{2}} , \\ where x = \vert x \vert \\ and y = \vert y \vert . \qquad ( 14 )$$

Substituting the above result in Eq. (14), the expression for patch-averaged tilt correlation becomes,

$$〈 {α}_{p 1} \cdot {α}_{p 2} 〉 = - ( \frac{2.91}{π} ) {( \frac{16}{π} )}^{2} {D}^{- 1 / 3} {\int }_{0}^{L} d z {C}_{n}^{2} ( z ) {\int }_{0}^{2 π} d δ {\int }_{0}^{∞} dx ( x {e}^{- 2 {x}^{2}} ) \times {\int }_{0}^{2 π} d ϑ {\int }_{0}^{1} d u [ ( u {cos}^{- 1} u ) - {u}^{2} ( 3 - 2 {u}^{2} ) \sqrt{1 - {u}^{2}} ] \times [ {{u}^{2} ( 1 - \frac{z}{L} )}^{2} + {( \frac{z d}{D L} )}^{2} \{ {x}^{2} + {( \frac{L}{d} Δ θ )}^{2} - 2 x \frac{L}{d} Δθcos δ \} + 2 u ( 1 - \frac{z}{L} ) ( \frac{z d}{D L} ) cos ϑ \sqrt{{x}^{2} + {( \frac{L}{d} Δ θ )}^{2} - 2 x \frac{L}{d} Δ θ cos δ} ] 5 \text{/} 6 . \qquad ( 15 )$$

The expression for patch-averaged tilt variance [symbol] αₚ² [symbol] can be obtained from Eq. (15) by setting Δθ=0. The differential patch-averaged tilt variance can hence be expressed as:

$$\begin{matrix}\begin{matrix}〈 {( {α}_{p 1} - {α}_{p 2} )}^{2} 〉 = 2 [ 〈 {α}_{p}^{2} 〉 - 〈 {α}_{p 1} \cdot {α}_{p 2} 〉 ] \\ = {\int }_{0}^{L} d z {C}_{n}^{2} ( z ) {f}_{d} ( z ) ,\end{matrix} \\ where & ( 16 ) \\ {f}_{d} ( z ) = - 1 \; 1.64 {( \frac{16}{π} )}^{2} {D}^{- 1 / 3} {\int }_{0}^{∞} dx ( x {e}^{- 2 {x}^{2}} ) \times {\int }_{0}^{2 π} d ϑ {\int }_{0}^{1} d u [ ( u {cos}^{- 1} u ) - {u}^{2} ( 3 - 2 {u}^{2} ) \sqrt{1 - {u}^{2}} ] \times {[ {{u}^{2} ( 1 - \frac{z}{L} )}^{2} + {( \frac{z d}{D L} x )}^{2} + 2 u ( 1 - \frac{z}{L} ) ( \frac{z d}{D L} x ) cos ϑ ]}^{5 / 6} + ( \frac{5.82}{π} ) {( \frac{16}{π} )}^{2} {D}^{- 1 / 3} {\int }_{0}^{2 π} d δ {\int }_{0}^{∞} dx ( x {e}^{- 2 {x}^{2}} ) \times {\int }_{0}^{2 π} d ϑ {\int }_{0}^{1} d u [ ( u {cos}^{- 1} u ) - {u}^{2} ( 3 - 2 {u}^{2} ) \sqrt{1 - {u}^{2}} ] \times [ {{u}^{2} ( 1 - \frac{z}{L} )}^{2} + {( \frac{z d}{D L} )}^{2} \{ {x}^{2} + {( \frac{L}{d} Δ θ )}^{2} - 2 x \frac{L}{d} Δθcos δ \} + 2 u ( 1 - \frac{z}{L} ) ( \frac{z d}{D L} ) cos ϑ \sqrt{{x}^{2} + {( \frac{L}{d} Δ θ )}^{2} - 2 x \frac{L}{d} Δ θ cos δ} ] 5 \text{/} 6 & ( 17 )\end{matrix}$$

is the path weighting function. No simpler form for the weighting function can be obtained, and hence in the present work, Eq. (17) is evaluated numerically for cases of interest.

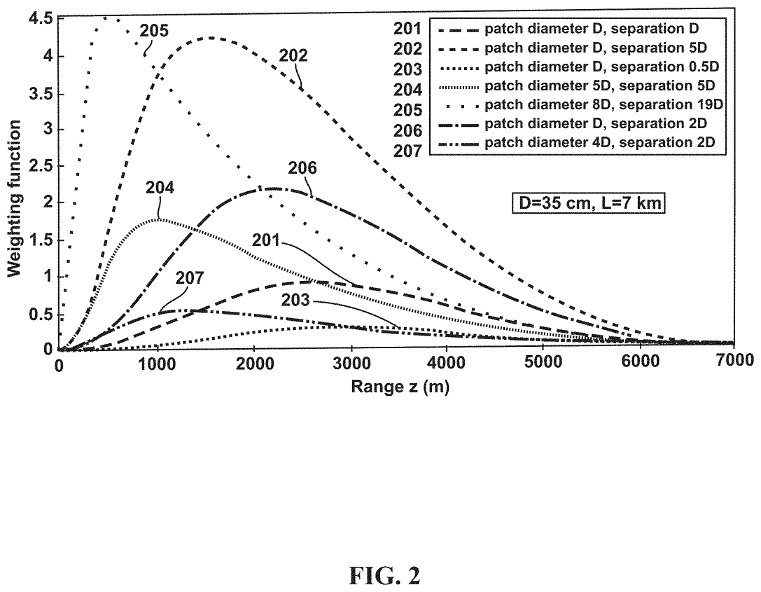

FIG. 2 is a graphical plot 200 of path weighting functions of differential patch-averaged tilt variances for different patch sizes and separations. The camera is at z=0 and the target is at z=7000 m. FIG. 2 shows the graphical plot 200 of f_{d}(z) for different patch sizes and separations. The weighting function drops to zero at both ends of the path. This implies that the turbulence near the target hardly affects the differential motion seen by the camera. The tilt due to turbulence at the camera is same for both patches since the two sensing paths converge at the camera. This explains the zero weighting of turbulence at the camera end of the path. The peak locations of these weighting functions depend on the patch size and separation relative to the imaging aperture. Sub-aperture sized patches and separations have weighting functions that peak towards the target end of the path. Larger patch sizes and separations have weighting functions that peak towards the camera end of the path.

B.2 Creating Arbitrary Weighting Function from Linear Combination of Path Weighting Functions: If the turbulence is presumed to be constant along the path, then the differential tilt variance associated with each pair of image patches would provide an estimate for Cₙ². If this presumption is not made, a set of tilt variances from pairs of patches of different sizes and separations can be seen as encoding differences in Cₙ² along the path. Members of a set of path weighting functions, from a variety of differently sized and separated image patches, each characterize the turbulence along (almost) the same path, but each weights that path differently. However, this rich set of weighting functions can be used as a basis set such that the weighting functions from this set can be linearly combined to reproduce the path weighting function associated with some atmospheric parameter of interest. To determine the appropriate linear combination of weighting functions, the Moore-Penrose pseudoinverse can be used to find the least-squares optimal way to achieve the desired weighting function in terms of the basis set available. Here it is shown that the weighting functions for differential patch-averaged tilt variances can be used to reproduce the weighting functions for the spherical wave r₀ and a scintillometer.

The spherical wave r0 is given by: [14]

$${r}_{0 , s w} = {[ 0.423 {k}^{2} {\int }_{0}^{L} d {z ( 1 - \frac{z}{L} )}^{5 / 3} {C}_{n}^{2} ( z ) ]}^{- 3 / 5} . \qquad ( 18 )$$

This equation has been written so the integration takes place from the camera to the object, i.e. the camera is at 0 and the target is at L as above. In this expression Cₙ² is weighted by z^{5/3} along the path. This is the same weighting as that of tilt variance due to a point source. Since there is no beacon or point source at the target, no part of the image corresponds to a weighting function of this form. By sampling the weighting functions along the path, and generating a matrix, M, where the rows are formed from the individual sampled weighting functions, and the columns then correspond to the range where these functions are sampled, the desired weights can be computed as W=M⁺F, where W is the weight to be applied to each weighting function, and F is the desired weighting function sampled the same way as, and M⁺ is the pseudoinverse. The success of this operation can then be revealed by examining MW, which is the actual weighting function generated by attempting to match F with a linear combination of functions drawn from M.

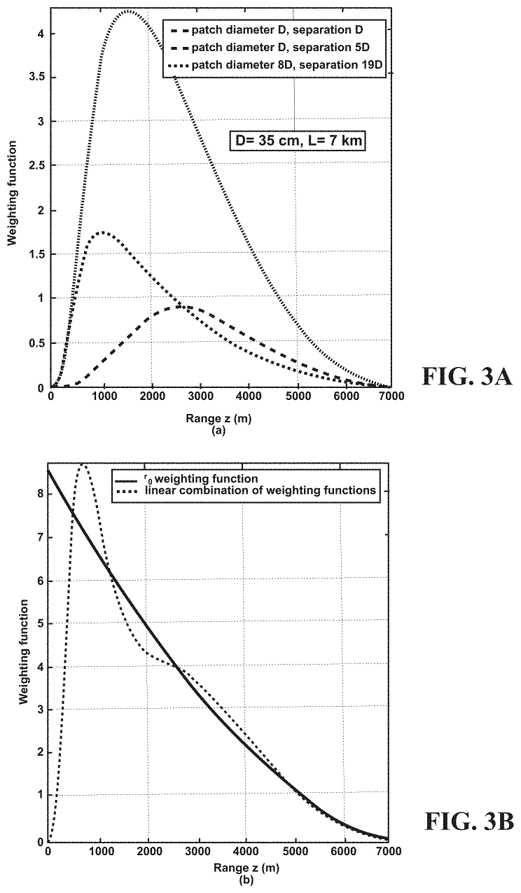

FIG. 3A is a graphical plot 300a of three path weighting functions. FIG. 3B is a graphical plot 300b of the linear combination of the three path weighting functions of FIG. 3A. Three path weighting functions in FIG. 3A linearly combined to obtain a weighting function very close to the r₀ weighting function in FIG. 3B. The camera is at z=0 and the target is at z=7000 m.

The Moore-Penrose technique is used here to obtain the pseudo-inverse. FIG. 3 shows how three different weighting functions corresponding to pairs of image patches of different sizes and separations are linearly combined to reproduce the weighting function for r_{0,sw}. The weighting function obtained from linear combination of weighting functions, matches the desired weighting function well, except for a small portion of the path close to the camera. So, unless there is significantly strong turbulence near the camera, it is possible to obtain a fair estimate of r₀ from the differential motion of these pairs of patches.

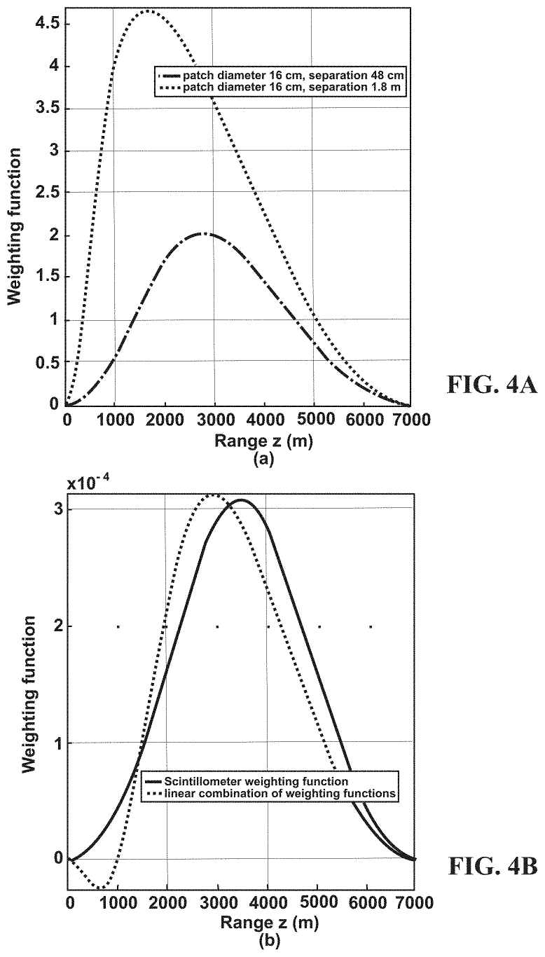

FIG. 4A is a graphical plot 400a of two path weighting functions. FIG. 4B is a graphical plot 400b of linear combination of the two path weighting functions of FIG. 4A. Two path weighting functions in FIG. 4A linearly combined to obtain a weighting function very close to the BLS 2000 scintillometer weighting function in FIG. 4B. The camera is at z=0 and the target is at z=7000 m.

FIGS. 4A-4B demonstrate how weighting functions corresponding to pairs of patches of two different separations can be linearly combined to approximate the Scintec BLS 2000 scintillometer weighting function. Though the two weighting functions do not match perfectly, the agreement is fairly good. The measured differential tilt variances are multiplied by the corresponding weights obtained from the pseudo-inverse technique and combined together to obtain an estimate of the desired turbulence parameter.

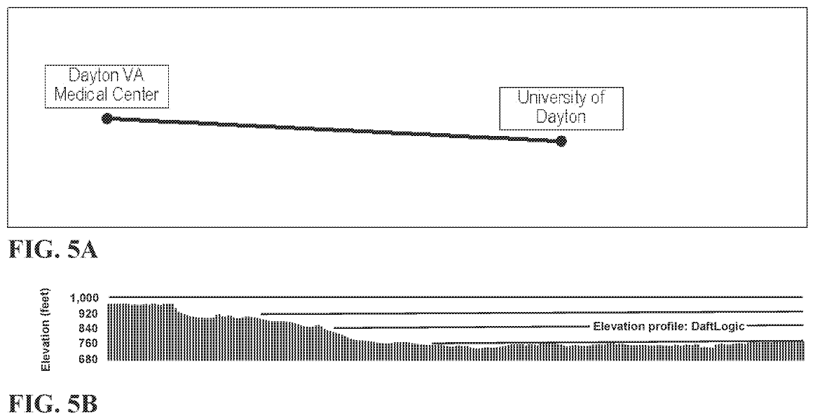

C. How the Invention can be used: The following example demonstrates how the method developed can be used to obtain an estimate of path-weighted Cₙ², such as that from a scintillometer. [15] The experiment was conducted in February 2017. Images of the Dayton VA Medical Center were captured from a window at University of Dayton's (UD) Intelligent Optics Laboratory. FIG. 5A depicts the layout of the 7 km path from the VA Medical Center to UD. FIG. 5B depicts a ground elevation profile of 7 km path of FIG. 5A.

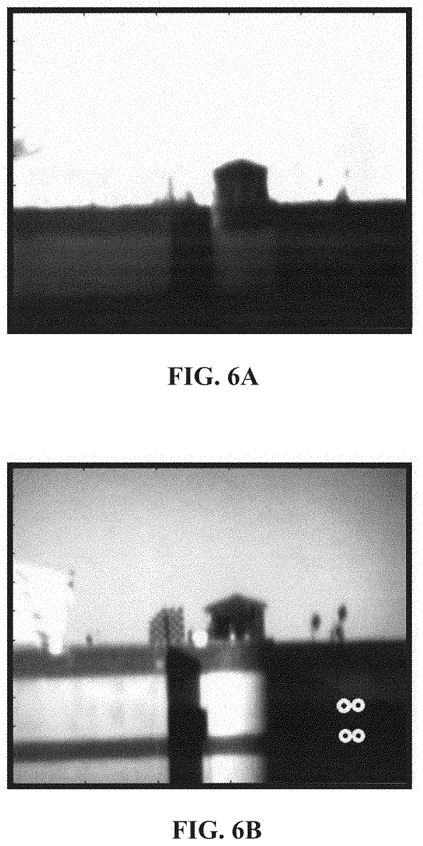

Example images are shown in FIGS. 6A-6B. The images were captured and saved every 40 s using a Manta G609 Allied Vision Technologies camera with a pixel pitch of 4.54 μm, mounted at the back of a 14 inch (35 cm) telescope with focal length of 3.91 m. The exposure time used was 10 ms. Turbulence was estimated by measuring the motion of four patches, marked as white circles in FIG. 6A, each centered at one of the corners of the two windows in the right wing of the hospital. A Scintec BLS 2000 scintillometer measured turbulence along nearly the same path. The BLS transmitter was a floor above the two tracked windows at the VA Medical Center and can be seen as the bright source at the center of FIG. 6A.

The four patches tracked were each of 1/e diameter 16 cm (20 pixels). Hence there were two pairs of patches separated by 48 cm, and two pairs of patches separated by 1.8 m at the target for each image. A 30 frame moving window, corresponding to twenty (20) minutes of imagery was used to compute the variance from the differential motion. The horizontal and vertical variances were added to obtain the total variance. The tilt variances for the two different patch separations were multiplied by their corresponding weights (computed using the pseudo-inverse technique mentioned in the previous section) and added together to obtain a path-weighted estimate of Cₙ². In essence, the path-weighting function for the Cₙ² estimate was the weighting function shown in FIG. 4B. The estimates were compared to the BLS 2000 scintillometer measurements.

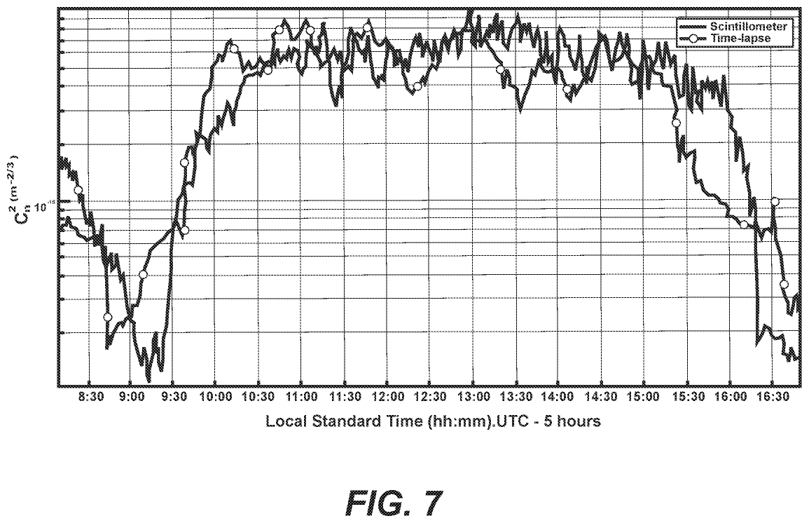

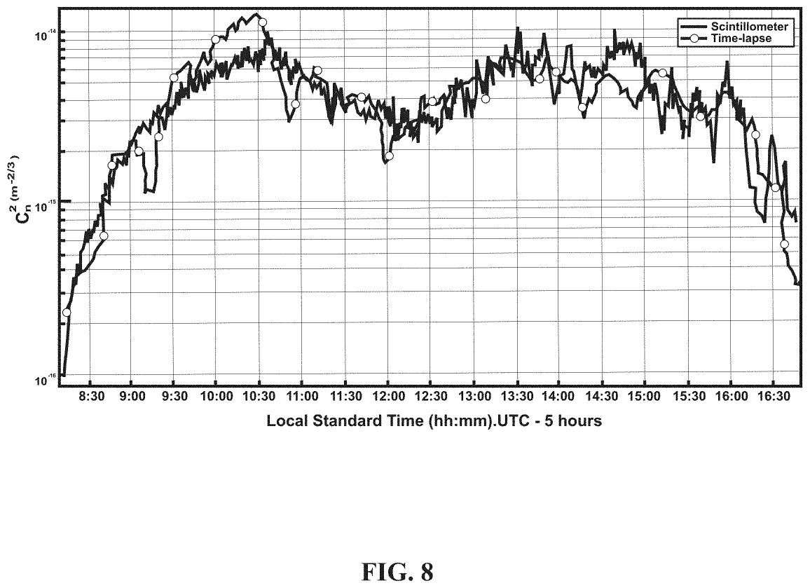

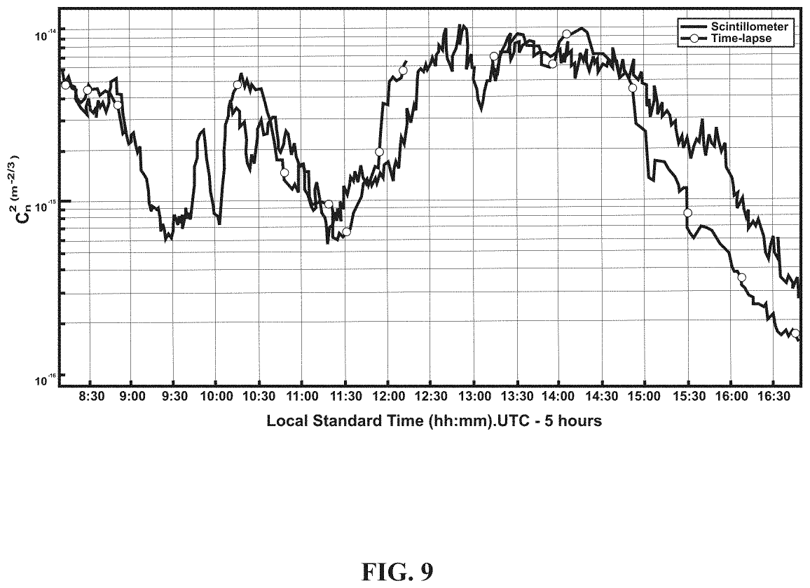

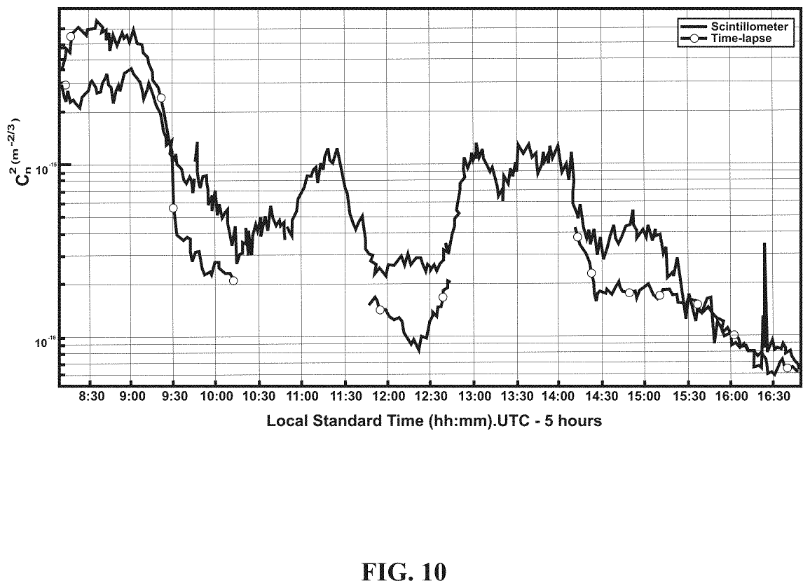

FIGS. 7-10 show the results of these comparisons for four days over different weather conditions. FIG. 7 is a graphical plot of a comparison of Cₙ² estimates from time-lapse imagery with Cₙ² from scintillometer: Feb. 14, 2017. Differences in the two profiles are possibly due to estimation errors resulting from moving shadows and poor image contrast during early morning and late afternoon. FIG. 8 is a graphical plot of a comparison of Cₙ² estimates from time-lapse imagery with Cₙ² from scintillometer: Feb. 15, 2017. Differences in the two profiles are possibly due to estimation errors resulting from moving shadows and poor image contrast during early morning and late afternoon. FIG. 9. Comparison of Cₙ² estimates from time-lapse imagery with Cₙ² from scintillometer: Feb. 18, 2017. Differences in the two profiles are possibly due to estimation errors resulting from moving shadows, contrast change in neighboring images due to changing cloud cover and poor image contrast during early morning and late afternoon. FIG. 10. Comparison of Cₙ² estimates from time-lapse imagery with Cₙ² from scintillometer: Feb. 21, 2017. Differences in the two profiles are possibly due to estimation errors resulting from moving shadows, contrast change in neighboring images due to changing cloud cover and poor image contrast during early morning and late afternoon.

According to meteorological observations, Feb. 14, 2017 was a clear day. As evident from FIG. 7, the time-lapse estimates agree very well with the scintillometer measurements. Throughout the experiment, the two windows being tracked were in the shadow for most of the day. Poor contrast during sunrise and sunset times and shadows sweeping across the windows during the early mornings (as seen in FIG. 6A) contributed to estimation error during these times. Feb. 15, 2017 was clear earlier during the day, but it became cloudy by mid-morning. Overcast conditions prevailed from around noon to 1:30 PM (local standard time), causing the dip in Cₙ², seen in FIG. 8. Again, there is excellent agreement between the time-lapse estimates and the scintillometer measurements. Feb. 18, 2017 was marked by alternating cloudy and clear conditions throughout the day. This resulted in multiple peaks and troughs in the profile, as seen in FIG. 9. The time-lapse estimates and scintillometer show agreeable trends and values. However, due to software issues, the camera failed to capture images intermittently, causing gaps in the time-lapse Cₙ² profile. Feb. 21, 2017 was a cloudy day, with clear conditions developing very late in the afternoon. The time-lapse estimates agree reasonably well with the scintillometer, as seen in FIG. 10, the gaps in the profile suggesting again lack of data due to software issues during collection. Poor contrast during cloudy conditions could have contributed to the slight differences in the two profiles.

Alternatives: The derivation of the weighting functions given in section B contains a presumption that the source patch is well modeled by the Gaussian window applied to the images. This presumption can be eliminated by using a measurement of the light intensity within each source window. In cases where this Gaussian window doesn't correspond well with the actual source patch detail, this approach will improve the accuracy of the method. To accomplish this, the Gaussian patch function introduced in equation 9 is replaced by the known intensity distribution of the patch being tracked. The known intensity distribution could be taken from the image set used, higher resolution images, or model data. The integrations which follow are then computed numerically. An intermediate approach is to compute the width (i.e. standard deviation) of the intensity distribution within each windowed source patch on the x and y axes and use these as the widths of the Gaussian windows used for the integrations. When these widths differ on x and y the derivation which follows needs to be modified to account for this bivariate Gaussian. In the cases of corners, edges, or small high contrast features, the width on one or both axes will be smaller than the Gaussian window applied, and this correction will prevent the turbulence from being overestimated.

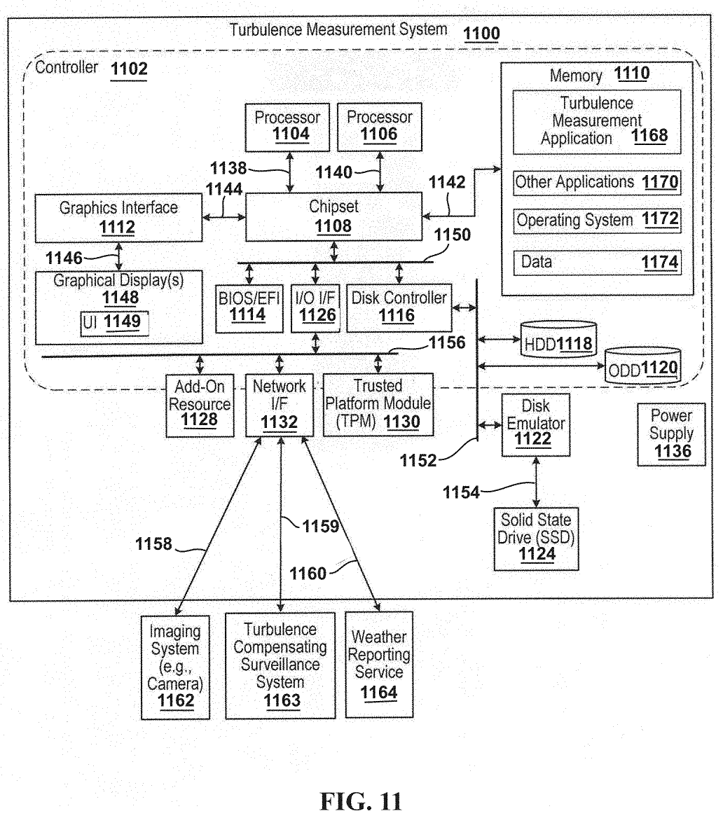

FIG. 11 is a diagrammatic illustration of an exemplary hardware and software environment of a turbulence measurement system 1100 managed by a controller 1102 consistent with embodiments of the innovation. Controller 1102 can be a customized implementation for the controller 102 (FIG. 1) Turbulence measurement system 1100 is in part a customized information handling system (IHS) that performs at least a part of the methodologies and features as described herein. Turbulence measurement system 1100 can include processing resources for executing machine-executable code, such as a central processing unit (CPU), a programmable logic array (PLA), an embedded device such as a System-on-a-Chip (SoC), or other control logic hardware. Turbulence measurement system 1100 can also include one or more computer-readable medium for storing machine-executable code, such as software or data. Additional components of Turbulence measurement system 1100 can include one or more storage devices that can store machine-executable code, one or more communications ports for communicating with external devices, and various input and output (I/O) devices, such as a keyboard, a mouse, and a video display. Turbulence measurement system 1100 can also include one or more interconnects or buses operable to transmit information between the various hardware components.

Turbulence measurement system 1100 includes processors 1104 and 1106, chipset 1108, memory 1110, graphics interface 1112, a basic input and output system/extensible firmware interface (BIOS/EFI) module 1114, disk controller 1116, hard disk drive (HDD) 1118, optical disk drive (ODD) 1120, disk emulator 1122 connected to an external solid state drive (SSD) 1124, input/output (I/O) interface (I/F) 1126, one or more add-on resources 1128, a trusted platform module (TPM) 1130, network interface 1132, and power supply 1136. Processors 1104 and 1106, chipset 1108, memory 1110, graphics interface 1112, BIOS/EFI module 1114, disk controller 1116, HDD 1118, ODD 1120, disk emulator 1122, SSD 1124, I/O interface 1126, add-on resources 1128, TPM 1130, and network interface 1132 operate together to provide a host environment of Turbulence measurement system 1100 that operates to provide the data processing functionality of the information handling system. The host environment operates to execute machine-executable code, including platform BIOS/EFI code, device firmware, operating system code, applications, programs, and the like, to perform the data processing tasks associated with Turbulence measurement system 1100.

In a host environment, processor 1104 is connected to chipset 1108 via processor interface 1138, and processor 1106 is connected to the chipset 1108 via processor interface 1140. Memory 1110 is connected to chipset 1108 via a memory bus 1142. Graphics interface 1112 is connected to chipset 1108 via a graphics bus 1144, and provides a video display output 1146 to graphical display(s) 1148 that presents UI 1149. In a particular embodiment, Turbulence measurement system 1100 includes separate memories that are dedicated to each of processors 1104 and 1106 via separate memory interfaces. An example of memory 1110 includes random access memory (RAM) such as static RAM (SRAM), dynamic RAM (DRAM), non-volatile RAM (NV-RAM), or the like, read only memory (ROM), another type of memory, or a combination thereof.

BIOS/EFI module 1114, disk controller 1116, and I/O interface 1126 are connected to chipset 1108 via an I/O channel 1150. An example of I/O channel 1150 includes a Peripheral Component Interconnect (PCI) interface, a PCI-Extended (PCI-X) interface, a high speed PCI-Express (PCIe) interface, another industry standard or proprietary communication interface, or a combination thereof. Chipset 1108 can also include one or more other I/O interfaces, including an Industry Standard Architecture (ISA) interface, a Small Computer Serial Interface (SCSI) interface, an Inter-Integrated Circuit (I2C) interface, a System Packet Interface (SPI), a Universal Serial Bus (USB), another interface, or a combination thereof. BIOS/EFI module 1114 includes BIOS/EFI code operable to detect resources within Turbulence measurement system 1100, to provide drivers for the resources, initialize the resources, and access the resources. BIOS/EFI module 1114 includes code that operates to detect resources within Turbulence measurement system 1100, to provide drivers for the resources, to initialize the resources, and to access the resources.

Disk controller 1116 includes a disk interface 1152 that connects the disk controller to HDD 1118, to ODD 1120, and to disk emulator 1122. An example of disk interface 1152 includes an Integrated Drive Electronics (IDE) interface, an Advanced Technology Attachment (ATA) such as a parallel ATA (PATA) interface or a serial ATA (SATA) interface, a SCSI interface, a USB interface, a proprietary interface, or a combination thereof. Disk emulator 1122 permits SSD 1124 to be connected to Turbulence measurement system 1100 via an external interface 1154. An example of external interface 1154 includes a USB interface, an IEEE 1394 (Firewire) interface, a proprietary interface, or a combination thereof. Alternatively, solid-state drive 1124 can be disposed within Turbulence measurement system 1100.

I/O interface 1126 includes a peripheral interface 1156 that connects the I/O interface to add-on resource 1128, to TPM 1130, and to network interface 1132. Peripheral interface 1156 can be the same type of interface as I/O channel 1142, or can be a different type of interface. As such, I/O interface 1126 extends the capacity of I/O channel 1142 when peripheral interface 1156 and the I/O channel are of the same type, and the I/O interface translates information from a format suitable to the I/O channel to a format suitable to the peripheral channel 1156 when they are of a different type. Add-on resource 1128 can include a data storage system, an additional graphics interface, a network interface card (NIC), a sound/video processing card, another add-on resource, or a combination thereof. Add-on resource 1128 can be on a main circuit board, on separate circuit board or add-in card disposed within turbulence measurement system 1100, a device that is external to the information handling system, or a combination thereof.

Network interface 1132 represents a network interface controller (NIC) disposed within Turbulence measurement system 1100, on a main circuit board of the information handling system, integrated onto another component such as chipset 1108, in another suitable location, or a combination thereof. Network interface 1132 includes network channels 1158, 1159 and 1160 that provide interfaces to devices that are external to turbulence measurement system 1100. In a particular embodiment, network channels 1158 and 1160 are of a different type than peripheral channel 1156 and network interface 1132 translates information from a format suitable to the peripheral channel to a format suitable to external devices. An example of network channels 1158-1160 includes InfiniBand channels, Fibre Channel channels, Gigabit Ethernet channels, proprietary channel architectures, or a combination thereof. Network channels 1158-1160 can be connected to external network resources such as an imaging system (e.g., camera) 1162, turbulence compensating surveillance system 1163, and a weather reporting service 1164. The network resource can include another information handling system, a data storage system, another network, a grid management system, another suitable resource, or a combination thereof.

Within memory 1110, HDD 1118, ODD 1120, or SSD 1124, one or more software and/or firmware modules and one or more sets of data can be stored that can be utilized during operations of turbulence measurement system 1100. These one or more software and/or firmware modules can be loaded into memory 1110 during operation of the Turbulence measurement system 1100. Specifically, in one embodiment, memory 1110 can include therein a plurality of such modules, including a turbulence measurement application 1168, one or more other applications 1170, operating system (OS) 1172, and data 1174. One example of data is airbag configuration data 1176 These software and/or firmware modules have varying functionality as disclosed herein when their corresponding program code is executed by processors 1104, 1106.

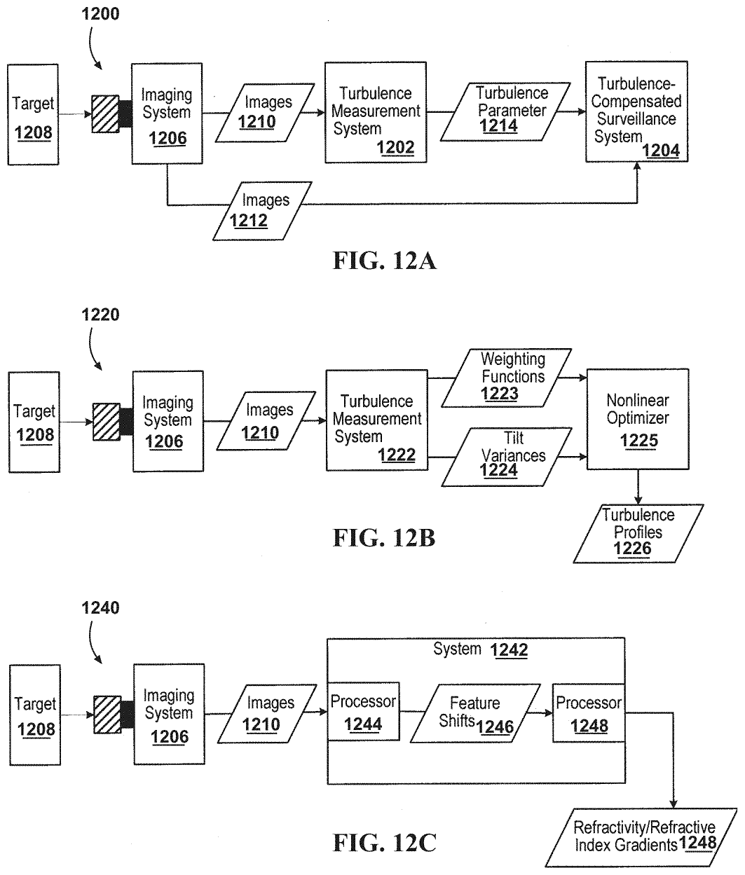

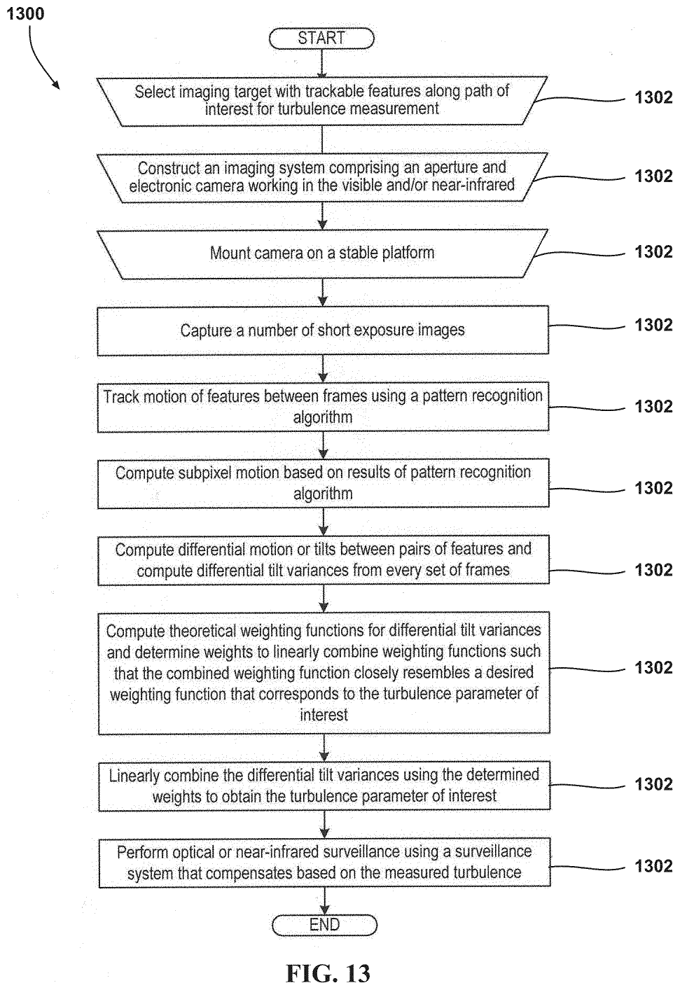

FIG. 12A is a functional block diagram of an example system 1200 that uses a turbulence measurement system 1202 that enables improved performance by a turbulence-compensated surveillance system 1204. Imaging system 1206 images target 1208 and provides images 1210 to the turbulence measurement system 1202 and provides images to a turbulence-compensated surveillance system 1202. Turbulence measurement system 1202 generates a turbulence parameter 1212 that is used by the turbulence-compensated surveillance system 1202.

In one or more embodiments, the turbulence measurement system uses the pseudoinverse technique to obtain the weights required to linearly combine the differential tilt variance weighting functions to obtain a weighting function that approximates the weighting function of a desired turbulence parameter. The measured differential tilt variances from the sample images are linearly combined according to the computed weights to get the turbulence parameter of interest. The images are blurred and warped due to turbulence. The calculated turbulence parameter can be used to generate a model of the Optical Transfer Function which can be used to deconvolve the turbulence degraded images to get pristine images for surveillance.

FIG. 12B is a functional block diagram of an example system 1220 that uses a turbulence measurement system 1222 that enables a nonlinear optimizer to provide turbulence profiles. In one or more embodiments, the turbulence measurement system uses a pattern recognition algorithm to identify trackable features in the images. A set of weighting functions for differential tilt variances is numerically computed for all pairs of feature separations. The corresponding differential tilt variances are computed. The weighting functions are related to the tilt variances through a linear system of equations where the turbulence strength at every sampled location along the path is the unknown to be solved. The turbulence strengths at different locations along the path can be solved through a suitable optimization routine that is robust to measurement noise. The turbulence distribution along the path can be integrated to generate any desirable integrated turbulence parameter or simply used for turbulence monitoring during a High Energy Laser (HEL) field testing or during tactical engagements. It will provide important information about how turbulence at different locations is affecting the HEL performance. If used from an airborne platform, the profiling information can be useful to understand how turbulence varies with height. Information about this is limited currently and the knowledge can help improve existing atmospheric models.

FIG. 12C is a functional block diagram of an example system that produces refractivity/refractive index gradient information. In one or more embodiments, the system uses a pattern recognition algorithm to compute the slow, deterministic motion of trackable features in the images over the course of several days due to refractive bending. Since curvature of a ray is related to refractive index gradient, this motion information can be used to obtain the temperature structure at a particular location, e.g. determine the lapse rate and how local weather conditions can influence it. Knowledge of these parameters will be used to improve existing atmospheric models. Refractivity information is useful for pointing/tracking in Directed Energy or Electro Optics Sensing applications.

In use, a method 1300 is provided that optically measures turbulence. Method 1300 includes selecting an imaging target with trackable features along path of interest for turbulence measurement (block 1302). Method 1300 includes constructing an imaging system comprising an aperture and electronic camera working in the visible and/or near-infrared (block 1304). The best results will be obtained by choosing an aperture large enough to resolve feature separations smaller than the aperture diameter and a camera with a sufficient number of pixels for features with separations larger than the aperture diameter to be captured in a single frame. Method 1300 includes mounting camera on a stable platform (block 1306). Method 1300 includes capturing a number of short exposure images (block 1308). In one or more embodiments, a few dozen images (e.g., 20-50) is sufficient. In one or more embodiments, capturing a few hundred images will give a lower noise result (e.g., 200-400). In one or more embodiments, the best results will be obtained by capturing images no faster than the atmospheric coherence time, with individual exposures at least as short as the atmospheric coherence time. The atmospheric coherence time is typically in the millisecond range so this will not be difficult with a modern digital camera.

Method 1300 includes tracking motion of features between frames using a pattern recognition algorithm (block 1310). Method 1300 includes computing subpixel motion based on results of the pattern recognition algorithm (block 1312). Method 1300 includes computing differential motion or tilts between pairs of features and compute differential tilt variances from every set of frames (block 1314). Method 1300 includes computing theoretical weighting functions for differential tilt variances and determine weights to linearly combine weighting functions such that the combined weighting function closely resembles a desired weighting function that corresponds to the turbulence parameter of interest (block 1316). Method 1300 includes linearly combining the differential tilt variances using the determined weights to obtain the turbulence parameter of interest (block 1318). Method 1300 includes performing optical or near-infrared surveillance using a surveillance system that compensates based on the measured turbulence (block 1320). Then method 1300 ends.

The following references cited above are hereby incorporated by reference in their entirety:
[1] R. Avila, J. Vernin, and E. Masciadri, “Whole atmospheric-turbulence profiling with generalized scidar,” Appl. Opt. 36 (30), 7898-7905 (1997).
[2] V. Kluckers, N. Wooder, T. Nicholls, M. Adcock, I. Munro, and J. Dainty, “Profiling of atmospheric turbulence strength and velocity using a generalized SCIDAR technique,” Astron. Astrophys. Suppl. Ser 130(1), 141-155 (1998).
[3] R. J. Hill, “Comparison of scintillation methods for measuring the inner scale of turbulence,” Appl. Opt. 27, 2187-2193 (1988).
[4] Z. Junwei, Q. Xiwen, F. Shuanglian, and Z. Zhigang, “Measurement of atmospheric refractive index structure constant near ground based on CAN bus,” in 10th International Conference on Electronic Measurements and Instruments (ICEMI), 2, 270-273 (2011).
[5] M. Sarazin and F. Roddier, “The ESO Differential Image Motion Monitor, “Astron. Astrophys. 227, 294-300 (1990).
[6] Butterley, T., Wilson, R. W., and Sarazin, M., “Determination of the profile of atmospheric optical turbulence strength from slodar data,” Mon. Not. R. Astron. Soc. 369, 835-845 (2006).
[7] MZA Corporation, “DELTA Imaging path turbulence monitor PM02-600,” https://www.mza.com/doc/misc/MZA_DELTA_PM-02-600_Specifications.pdf
[8] MZA Corporation, “Path-resolved optical profiler system (PROPS) PR-05-600,” https://www.mza.com/doc/misc/MZA_PROPS_PR-05-600_Specifications.pdf
[9] DELTA Imaging Path Turbulence Monitor, www.mza.com/products.php?page=productsAtmosChar&print.
[10] D. Fried, “Differential angle of arrival: theory, evaluation, and measurement feasibility,” Rad. Sci. 10(1), 71-76 (1975).
[11] M. Roggemann, and B. Welsh, [Imaging through Turbulence], CRC Press, Boca Raton, Fla. (1996).
[12] D. Fried, “Varieties of isoplanatism,” in Imaging through the Atmosphere, J. C. Wyant, ed., Proc. SPIE 75, 20-29 (1976).
[13] K. Winick, and D. Marquis, “Stellar scintillation technique for the measurement of tilt anisoplanatism,” J. Opt. Soc. Am. A 5(11), 1929-1936 (1988).
[14] J. D. Schmidt, [Numerical Simulation of Optical Wave Propagation], SPIE Press, Bellingham, Wash. (2010).
[15] S. R. Bose-Pillai, J. E. McCrae, C. A. Rice, R. A. Wood, C. E. Murphy, and S. T. Fiorino, “Estimation of atmospheric turbulence using differential motion of extended features in time-lapse imagery,” Opt. Eng. 57(10), 104108 (2018).
[16] http://vortex.plymouth.edu/myo/sfc/statlog-a.html.

While the disclosure has been described with reference to exemplary embodiments, it will be understood by those skilled in the art that various changes may be made and equivalents may be substituted for elements thereof without departing from the scope of the disclosure. In addition, many modifications may be made to adapt a particular system, device or component thereof to the teachings of the disclosure without departing from the essential scope thereof. Therefore, it is intended that the disclosure not be limited to the particular embodiments disclosed for carrying out this disclosure, but that the disclosure will include all embodiments falling within the scope of the appended claims. Moreover, the use of the terms first, second, etc. do not denote any order or importance, but rather the terms first, second, etc. are used to distinguish one element from another.

In the preceding detailed description of exemplary embodiments of the disclosure, specific exemplary embodiments in which the disclosure may be practiced are described in sufficient detail to enable those skilled in the art to practice the disclosed embodiments. For example, specific details such as specific method orders, structures, elements, and connections have been presented herein. However, it is to be understood that the specific details presented need not be utilized to practice embodiments of the present disclosure. It is also to be understood that other embodiments may be utilized and that logical, architectural, programmatic, mechanical, electrical and other changes may be made without departing from general scope of the disclosure. The following detailed description is, therefore, not to be taken in a limiting sense, and the scope of the present disclosure is defined by the appended claims and equivalents thereof.

References within the specification to “one embodiment,” “an embodiment,” “embodiments”, or “one or more embodiments” are intended to indicate that a particular feature, structure, or characteristic described in connection with the embodiment is included in at least one embodiment of the present disclosure. The appearance of such phrases in various places within the specification are not necessarily all referring to the same embodiment, nor are separate or alternative embodiments mutually exclusive of other embodiments. Further, various features are described which may be exhibited by some embodiments and not by others. Similarly, various requirements are described which may be requirements for some embodiments but not other embodiments.

It is understood that the use of specific component, device and/or parameter names and/or corresponding acronyms thereof, such as those of the executing utility, logic, and/or firmware described herein, are for example only and not meant to imply any limitations on the described embodiments. The embodiments may thus be described with different nomenclature and/or terminology utilized to describe the components, devices, parameters, methods and/or functions herein, without limitation. References to any specific protocol or proprietary name in describing one or more elements, features or concepts of the embodiments are provided solely as examples of one implementation, and such references do not limit the extension of the claimed embodiments to embodiments in which different element, feature, protocol, or concept names are utilized. Thus, each term utilized herein is to be given its broadest interpretation given the context in which that terms is utilized.

The terminology used herein is for the purpose of describing particular embodiments only and is not intended to be limiting of the disclosure. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

The description of the present disclosure has been presented for purposes of illustration and description, but is not intended to be exhaustive or limited to the disclosure in the form disclosed. Many modifications and variations will be apparent to those of ordinary skill in the art without departing from the scope of the disclosure. The described embodiments were chosen and described in order to best explain the principles of the disclosure and the practical application, and to enable others of ordinary skill in the art to understand the disclosure for various embodiments with various modifications as are suited to the particular use contemplated.

What is claimed is:

1. A turbulence-compensating system comprising:
an image capturing device that captures frames of images of a target; and
a turbulence measurement system comprising a controller that is communicatively coupled to the image capturing device to receive the images, and which:
tracks motion of one or more features of the images between frames using a pattern recognition algorithm;
computes subpixel motion based on results of the pattern recognition algorithm;
computes differential motion or tilts between pairs of features;
computes differential tilt variances from every set of frames;
computes theoretical weighting functions for differential tilt variances;
determines weights to linearly combine weighting functions such that the combined weighting function closely resembles a desired weighting function that corresponds to the turbulence parameter of interest; and
linearly combines the differential tilt variances using the determined weights to obtain the turbulence parameter of interest.

2. The turbulence-compensating system of claim 1, wherein the image capturing device comprises a digital camera operating one or more of a visible range and a near infrared range and having an aperture large enough to resolve feature separations smaller than a diameter of the aperture, the camera having a sufficient number of pixels for features with separations larger than the diameter of the aperture to be captured in a single frame.

3. The turbulence-compensating system of claim 1, wherein the image capturing device captures a number frames of images in a range of 20-50.

4. The turbulence-compensating system of claim 1, wherein the image capturing device captures a number frames of images in a range of 200-500.

5. The turbulence-compensating system of claim 1, wherein the image capturing device captures frames no faster than an atmospheric coherence time, with individual exposures at least as short as the atmospheric coherence time.

6. The turbulence-compensating system of claim 1, wherein the turbulence measurement is used to compensate one of: (a) a surveillance system; (b) a nonlinear optimizer; and (c) an experimental measurement of a laser-emitting device.

7. A method comprising:
capturing frames of images a target using an image capturing device;
tracking motion of one or more features of the images between frames using a pattern recognition algorithm;
computing subpixel motion based on results of the pattern recognition algorithm;
computing differential motion or tilts between pairs of features;
computing differential tilt variances from every set of frames;
computing theoretical weighting functions for differential tilt variances;
determining weights to linearly combine weighting functions such that the combined weighting function closely resembles a desired weighting function that corresponds to the turbulence parameter of interest; and
linearly combining the differential tilt variances using the determined weights to obtain the turbulence parameter of interest.
